(19) United States
(12) Patent Application Publication
(10) Pub. No.: US 2026/0350969 A1
(43) Pub. Date: Nov. 5, 2026

(54) METHOD, APPARATUS, DEVICE AND STORAGE MEDIUM FOR INFORMATION PROCESSING

(71) Applicant: Beijing Zitiao Network Technology Co., Ltd., Beijing (CN)

(72) Inventors: Liyang Liu, Beijing (CN); Xun Wang, Beijing (CN); Chao Liao, Beijing (CN); Zhengxiong Luo, Beijing (CN); Zhi Tian, Beijing (CN); Weilin Huang, Beijing (CN)

(21) Appl. No.: 19/662,974

(22) Filed: Apr. 29, 2026

(30) Foreign Application Priority Data
Apr. 29, 2025 (CN) 202510561031.2

(51) Int. Cl. G06V 10/77; G06N 3/0455; G06T 5/70

(52) U.S. Cl. CPC G06V 10/7715; G06N 3/0455; G06T 5/70; G06T 2207/20182

(57) ABSTRACT

A method, an apparatus, a device, and a storage medium for information processing are provided. A processing request for a target model is obtained. In response to the processing request including input visual content, a first visual feature of the input visual content is determined using a first visual encoding model, and a second visual feature of the input visual content is determined using a second visual encoding model, and the first visual encoding model is different from the second visual encoding model. A sequence of input feature units corresponding to the processing request is constructed at least based on the first visual feature and the second visual feature. At least one output feature unit generated by the target model based on the sequence of input feature units is obtained, to generate response content for the processing request.

### CROSS-REFERENCE

The present application claims priority to Chinese Patent Application No. 202510561031.2, filed on Apr. 29, 2025 and entitled “METHOD, APPARATUS, DEVICE AND STORAGE MEDIUM FOR INFORMATION PROCESSING”, the entirety of which is incorporated herein by reference.

### TECHNICAL FIELD

The example embodiments of the present disclosure generally relate to the field of computers, and particularly relate to a method, an apparatus, a device, and a computer-readable storage medium for information processing.

### BACKGROUND

With the development of computer technology, the demand for network models has been increasing. Current models have become more mature in processing images. For example, a model can generate corresponding textual descriptions according to an input image, or can generate an image according to a description. However, the accuracy of the response results of current models still needs to be improved.

### SUMMARY

In a first aspect of the present disclosure, a method for information processing is provided. The method includes: obtaining a processing request for a target model; determining a first visual feature of input visual content using a first visual encoding model and determining a second visual feature of the input visual content using a second visual encoding model in response to the processing request including the input visual content, the first visual encoding model being different from the second visual encoding model; constructing a sequence of input feature units corresponding to the processing request at least based on the first visual feature and the second visual feature; and obtaining at least one output feature unit generated by the target model based on the sequence of input feature units, to generate response content for the processing request.

In a second aspect of the present disclosure, an apparatus for information processing is provided. The apparatus includes: an obtaining module configured to obtain a processing request for a target model; a determination module configured to determine, in response to the processing request including input visual content, a first visual feature of the input visual content using a first visual encoding model, and determine a second visual feature of the input visual content using a second visual encoding model, the first visual encoding model being different from the second visual encoding model; a construction module configured to construct a sequence of input feature units corresponding to the processing request at least based on the first visual feature and the second visual feature; and a generation module configured to obtain at least one output feature unit generated by the target model based on the sequence of input feature units, to generate response content for the processing request.

In a third aspect of the present disclosure, an electronic device is provided. The electronic device includes at least one processor; and at least one memory coupled to the at least one processor and storing instructions for execution by the at least one processor. When executed by the at least one processor, the instructions cause the electronic device to perform the method according to the first aspect.

In a fourth aspect of the present disclosure, a computer-readable storage medium is provided. The computer-readable storage medium has a computer program stored thereon, and the computer program is executable by a processor to implement the method of the first aspect.

In a fifth aspect of the present disclosure, a computer program product is provided. The computer program product includes computer-executable instructions, which, when executed by a processor, implement the method of the first aspect of the present disclosure.

It should be understood that the contents described in this section are not intended to limit the key features or important features of the embodiments of the present disclosure, nor to limit the scope of the present disclosure. Other features of the present disclosure will become apparent from the following description.

### BRIEF DESCRIPTION OF THE DRAWINGS

With reference to the accompanying drawings and the following detailed description, the above and other features, advantages, and aspects of the embodiments of the present disclosure will become more apparent. In the drawings, the same or similar reference numerals denote the same or similar elements, in which:

FIG. 1 illustrates a schematic diagram of an example environment in which embodiments of the present disclosure can be implemented;

FIG. 2 illustrates a first flowchart of a process of information processing according to some embodiments of the present disclosure;

FIG. 3A illustrates a second flowchart of a process of information processing according to some embodiments of the present disclosure;

FIG. 3B illustrates a third flowchart of a process of information processing according to some embodiments of the present disclosure;

FIG. 4 illustrates a schematic diagram of position embedding according to some embodiments of the present disclosure;

FIG. 5 illustrates a schematic diagram of frequency allocation according to some embodiments of the present disclosure;

FIG. 6 illustrates a schematic diagram of a sequence of training feature units according to some embodiments of the present disclosure;

FIG. 7 illustrates a schematic diagram of an attention mask according to some embodiments of the present disclosure;

FIG. 8 illustrates a schematic diagram of interaction according to some embodiments of the present disclosure;

FIG. 9 illustrates a schematic structural block diagram of an apparatus for information processing according to some embodiments of the present disclosure; and

FIG. 10 illustrates a block diagram of an electronic device capable of implementing multiple embodiments of the present disclosure.

### DETAILED DESCRIPTION OF EMBODIMENTS

The embodiments of the present disclosure will be described in greater detail below with reference to the accompanying drawings. Although certain embodiments of the present disclosure are illustrated in the drawings, it should be understood that the present disclosure may be implemented in various forms and should not be construed as limited to the embodiments set forth herein. Instead, the provided embodiments are intended to enable a thorough and complete understanding of the present disclosure. It should be understood that the drawings and embodiments of the present disclosure are provided for example purposes only and are not intended to limit the scope of protection of the present disclosure.

It should be noted that any titles of sections or subsections provided herein are not limiting. Various embodiments are described throughout herein, and any type of embodiment may be included under any section or subsection. In addition, the embodiments described in any section or subsection may be combined in any manner with any other embodiments described in the same or different sections or subsections.

In the description of the embodiments of the present disclosure, the term “comprising” and similar expressions should be understood as open-ended inclusion, that is, “including but not limited to.” The term “based on” should be understood as “at least partially based on.” The terms “an embodiment” or “the embodiment” should be understood as “at least one embodiment.” The term “some embodiments” should be understood as “at least some embodiments.” Other explicit and implicit definitions may also be included below. The terms “first,” “second,” and the like may refer to different or identical objects. Other explicit and implicit definitions may also be included below.

The embodiments of the present disclosure may involve user data, data acquisition, and/or usage of data. These aspects comply with applicable laws, regulations, and relevant requirements. In the embodiments of the present disclosure, all data collection, acquisition, processing, handling, transmission, and use are performed on the premise that the user is informed and has given consent. Accordingly, when implementing the embodiments of the present disclosure, the types of data or information that may be involved, the scope of use, and the use scenarios should be disclosed to the user and authorization should be obtained from the user in an appropriate manner in accordance with relevant laws and regulations. The specific manner of disclosure and/or authorization may vary depending on actual conditions and application scenarios, and the scope of the present disclosure is not limited in this regard.

In the solutions described in this specification and the embodiments thereof, if the processing of personal information is involved, such processing will be conducted only on the basis of legitimate grounds (for example, obtaining the consent of the personal information subject, or when necessary for the performance of a contract), and will be carried out only within the prescribed or agreed scope. A user's refusal to provide personal information other than that necessary for basic functions will not affect the user's ability to use the basic functions.

To satisfy users' diverse requirements for models, a variety of generative models have been created at the right moment, such as text generation models, image generation models, etc. However, these models use unimodal data as input and generate unimodal output. In this way, although the corresponding generation tasks may be completed, the models cannot process multimodal information, which greatly limits the application effects of the models. Then, some model research efforts targeting multimodal input have been made, but these models cannot generate highly accurate responses.

The embodiments of the present disclosure provide a solution for information processing. According to the solution, a processing request for a target model is obtained; in response to the processing request including input visual content, a first visual feature of the input visual content is determined using a first visual encoding model, and a second visual feature of the input visual content is determined using a second visual encoding model, the first visual encoding model being different from the second visual encoding model; an input feature unit sequence corresponding to the processing request is constructed based at least on the first visual feature and the second visual feature; and at least one output feature unit generated by the target model based on the input feature unit sequence is obtained, to generate response content for the processing request.

Based on this approach, the embodiments of the present disclosure are capable of extracting features of input visual content from different perspectives using the first visual encoding model and the second visual encoding model, respectively, so that more comprehensive features may be extracted, and more accurate response content may be generated accordingly.

### Example Environment

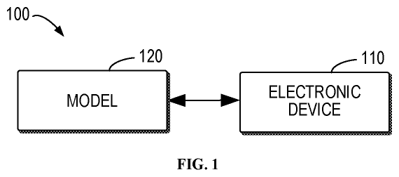

FIG. 1 illustrates a schematic diagram of an example environment 100 in which embodiments of the present disclosure can be implemented. As shown in FIG. 1, the example environment 100 may include an electronic device 110. In some embodiments, the electronic device 110 may obtain a processing request for a target model 120; in response to the processing request including input visual content, determine a first visual feature of the input visual content using a first visual encoding model, and determine a second visual feature of the input visual content using a second visual encoding model, the first visual encoding model being different from the second visual encoding model; construct a sequence of input feature units corresponding to the processing request at least based on the first visual feature and the second visual feature; and obtain at least one output feature unit generated by the target model 120 based on the sequence of input feature units, to generate response content for the processing request. The target model 120 may be deployed on the electronic device 110, or may also be deployed on another device, which will not be further described herein.

In some embodiments, the electronic device 110 may be any type of mobile terminal, fixed terminal, or portable terminal, including a mobile phone, a desktop computer, a laptop computer, a notebook computer, a netbook computer, a tablet computer, a media computer, a multimedia tablet, a handheld computer, a portable game terminal, a VR/AR device, a personal communication system (PCS) device, a personal navigation device, a personal digital assistant (PDA), an audio/video player, a digital camera/camcorder, a positioning device, a television receiver, a radio broadcast receiver, an e-book device, a game device, or any combination of the foregoing, including accessories and peripherals of these devices or any combination thereof. In some embodiments, the electronic device 110 may also support any type of interface for a target user (such as a “wearable” circuit, etc.).

The electronic device 110 may also be an independent physical server, or a server cluster or a distributed system composed of multiple physical servers, or a cloud server providing basic cloud computing services such as cloud service, cloud database, cloud computing, cloud functions, cloud storage, network services, cloud communication, middleware services, domain name services, security services, content delivery network, as well as big data and artificial intelligence platforms. For example, the electronic device 110 may include a computing system/server, such as a mainframe, an edge computing node, or a computing device in a cloud environment, and so on.

It should be understood that the structures and functions of the embedded elements in the environment 100 are described merely for illustrative purposes, and do not imply any limitation to the scope of the present disclosure.

The following will continue to describe some example embodiments of the present disclosure with reference to the accompanying drawings.

### Example Process

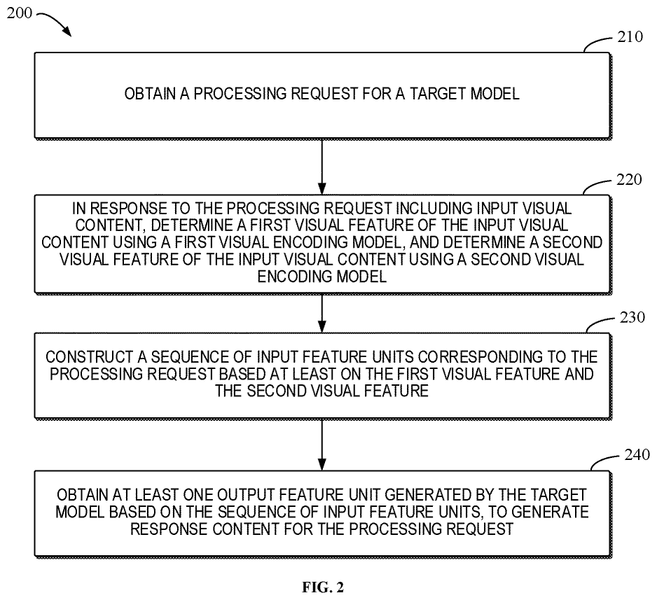

FIG. 2 illustrates a flowchart of a process 200 of information processing according to some embodiments of the present disclosure. The process 200 may be implemented at the electronic device 110. The process 200 will be described below with reference to FIG. 1.

At block 210, the electronic device 110 obtains a processing request for a target model.

In some embodiments, in order to meet the demand for processing multimodal information, the target model may be constructed. The target model includes a plurality of processing blocks, each of the processing blocks including a first attention unit, a second attention unit and a fusion unit. The first attention unit is configured to process a first visual feature and a text feature unit in a sequence of input feature units, the second attention unit is configured to process a second visual feature, and the fusion unit is configured to fuse a first output result of the first attention unit and a second output result of the second attention unit. The target model may process multimodal information, so that the processing request may include input visual content and input text content.

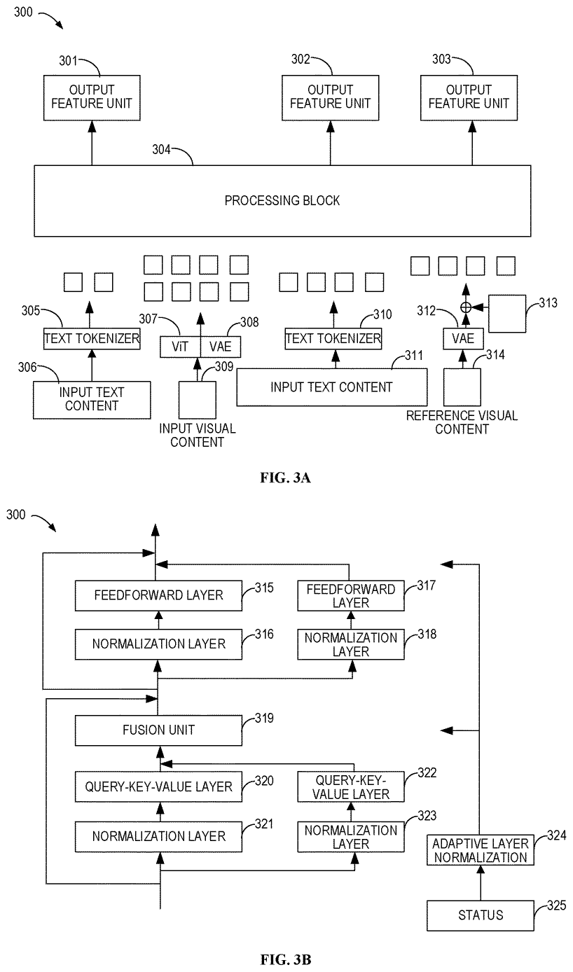

For example, with reference to FIG. 3A, the target model includes a plurality of processing blocks 304; with reference to FIG. 3B, each processing block 304 includes an attention layer, and the attention layer includes the first attention unit, the second attention unit and the fusion unit. The first attention unit includes a normalization layer 321 and a query-key-value layer 320, the second attention unit includes a normalization layer 323 and a query-key-value layer 322, and the attention layer includes a fusion unit 319, which is a multimodal multi-head self-attention layer. A first set of parameters of the first attention unit is independent of a second set of parameters of the second attention unit.

In some embodiments, with reference to FIG. 3B, each processing block 304 may further include a first feedforward unit and a second feedforward unit. The first feedforward unit includes a normalization layer 316 and a feedforward layer 315, and the second feedforward unit includes a normalization layer 318 and a feedforward layer 317. In this way, when the target model processes multimodal input information including text and an image, a unified attention layer may be used to simultaneously process an image feature unit corresponding to the image and a text feature unit corresponding to the text. Since there are differences between the image modality and the text modality, different feedforward units are applied for processing, thereby improving the model's processing performance for multimodal information.

At block 220, the electronic device 110 determines, in response to the processing request including input visual content, a first visual feature of the input visual content using a first visual encoding model, and determines a second visual feature of the input visual content using a second visual encoding model.

In some embodiments, if the processing request includes input visual content, the target model needs to process the visual content. Because the capabilities of different visual encoding models are different, the effects of extracting visual content features are different. In order to improve the understanding capability of the target model for visual content, different visual encoding models may be applied to determine visual features of the visual content. Therefore, the first visual encoding model is different from the second visual encoding model.

In some embodiments, the first visual encoding model includes a vision transformer-based encoding model, and the second visual encoding model includes a variational autoencoder-based encoding model. The vision transformer-based encoding model such as the Vision Transformer (ViT model) divides an image into multiple image blocks and performs global modeling using the self-attention mechanism of the transformer, to capture the long-distance dependencies in the image. Therefore, the ViT model is suitable for the field of image understanding. The variational autoencoder-based encoding model such as the Variational Autoencoder (VAE model) maps an image to a probability distribution in a latent space, to implement the modeling and generation of complex data distribution. Therefore, the VAE model is more suitable for the field of image generation. To simultaneously have the image generation capability and the image understanding capability, the first visual encoding model may be determined as the ViT model, and the second visual encoding model may be determined as the VAE model. For example, if the processing request includes an input image, the ViT model may be applied to determine the first visual feature of the input image, and the VAE model may be utilized to determine the second visual feature of the input image.

At block 230, the electronic device 110 constructs a sequence of input feature units corresponding to the processing request at least based on the first visual feature and the second visual feature.

In some embodiments, since the processing request includes the input text content and the input visual content, the text feature corresponding to the input text content may be determined, and then, based on the first visual feature, the second visual feature, and the text content, the sequence of input feature units corresponding to the processing request may be constructed. With reference to FIG. 3A, the input text content 306 may be processed through a text tokenizer 305 to obtain the text feature. In addition, the input visual content 309 may be processed through a first visual encoding model 307 to obtain the first visual feature, and the input visual content 309 may be processed through a second visual encoding model 308 to obtain a second visual feature. Then, based on the first visual feature, the second visual feature, and the text content, the sequence of input feature units corresponding to the processing request may be constructed, and the sequence of input feature units is input into the processing block 304.

In some embodiments, the target model may process multiple types of tasks. If the task of the target model is an image generation task and the processing request includes input text content, an initial noise image may be obtained, and a text feature unit corresponding to the text content and a visual feature unit corresponding to the noise image may be determined. Then, a normalization layer 321 and a query-key-value layer 320 in the first attention unit may be applied to process the text feature unit, so as to generate a feature matrix corresponding to the text feature unit. Meanwhile, a normalization layer 323 and a query-key-value layer 322 in the second attention unit may be applied to process the visual feature unit, so as to generate a feature matrix corresponding to the visual feature unit.

Then, a cross-modal fusion is performed on the feature matrix corresponding to the text feature unit and the feature matrix corresponding to the visual feature unit through the fusion unit 319, to obtain a fused feature unit. The obtained fused feature unit includes a feature matrix corresponding to the text modality and the feature matrix corresponding to an image modality. A normalization layer 316 and a feedforward layer 315 in the first feedforward unit are applied to process the feature matrix corresponding to the text modality, and a normalization layer 318 and a feedforward layer 317 in the second feedforward unit are applied to process the feature matrix corresponding to the image modality. Then, the output results of the first feedforward unit and the second feedforward unit are input into a next processing block.

Through this method, the text feature and the image feature in the target model are deeply fused in each processing block, so that the target model may achieve a high-quality effect of image generation without relying on a text encoder required by a conventional text-to-image model.

In some embodiments, the visual feature may also be adjusted through adaptive layer normalization (AdaLN). For example, referring to FIG. 3B, in each processing block of the target model, the time step embedding dynamically adjusts the statistical characteristics of a visual feature map of the processing block through the adaptive layer normalization 324, thereby controlling the behavior of the generation process at different time steps, and enabling the target model to adaptively predict the velocity field according to the current time step.

In some embodiments, if the processing request includes input visual content, and at this time, the input visual content is used as a model condition, the first visual feature and the second visual feature corresponding to the input visual content may be obtained, where the first visual feature is generated by the first visual encoding model, and the second visual feature is generated by the second visual encoding model. Then, the normalization layer 321 and the query-key-value layer 320 in the first attention unit are applied to process the feature unit corresponding to the first visual feature, to generate the feature matrix corresponding to the first visual feature. Meanwhile, the normalization layer 323 and the query-key-value layer 322 in the second attention unit are applied to process a feature unit corresponding to the second visual feature, to generate a feature matrix corresponding to the second visual feature.

Then, the feature matrix corresponding to the first visual feature and the feature matrix corresponding to the second visual feature are fused across modalities by the fusion unit 319, to obtain a fused feature unit. The obtained fused feature unit includes the feature matrix corresponding to the first visual feature and the feature matrix corresponding to the second visual feature. The feature matrix corresponding to the first visual feature is processed by the normalization layer 316 and the feedforward layer 315 in the first feedforward unit, and the feature matrix corresponding to the second visual feature is processed by the normalization layer 318 and the feedforward layer 317 in the second feedforward unit. Then, output results of the first feedforward unit and the second feedforward unit are input into the next processing block.

In some embodiments, in order to enhance the position perception capability of the target model, position information embedding may be performed for the feature unit before attention calculation. The electronic device 110 may determine, for the target feature unit in the sequence of input feature units, index information of the target feature unit based on a position of the target feature unit in the sequence of input feature units and a type of the target feature unit. Then, based on the index information, attention information associated with the target feature unit is determined. The index information serves as a position embedding identifier corresponding to the target feature unit, and is used to provide position information for each feature unit in the sequence.

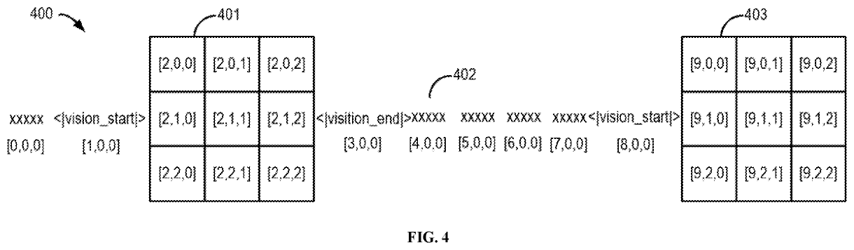

In some embodiments, since the processing request includes input text content, and the text content is only related to a time dimension, for the text content, the electronic device 110 may determine, in response to the target feature unit corresponding to the text content, a first value of a first dimension of index information based on a sequence position, and then set other dimensions of the index information to predetermined values. For example, with reference to FIG. 4, for a target feature unit 402 corresponding to the text content, index information [4,0,0] corresponding to the target feature unit 402 may be determined according to the sequence position. In the index information [4,0,0], “4” is the first value of the first dimension, and “[0,0]” are the predetermined values.

In some embodiments, the first dimension may be a time dimension, and the index information corresponding to the target feature unit 402 may sequentially increase according to the time dimension. For example, the index information corresponding to a next feature unit of the target feature unit 402 may be [5,0,0], and the index information corresponding to a further next feature unit may be [6,0,0], and so on. In addition, since the text content is only related to the time dimension, the values of other dimensions of the index information may be set to predetermined values to facilitate model processing.

In some embodiments, since the processing request includes input visual content, and the visual content is related to both a time dimension and a spatial dimension, for the visual content, the electronic device 110 may, in response to the target feature unit corresponding to an image block in an image, determine a second value of the first dimension of the index information based on the sequence position, where a plurality of feature units corresponding to the image are associated with the same sequence position. Then, the electronic device 110 may determine a third value of a second dimension of the index information and a fourth value of a third dimension of the index information based on a two-dimensional position of the image block in the image.

For example, with reference to FIG. 4, if the input visual content is an image, the image is related to the time dimension and the spatial dimension. The time dimension T may be determined as the first dimension. Since the image is two-dimensional, the spatial dimension includes width and height. A height H in the spatial dimension may be determined as the second dimension, and a width W in the spatial dimension may be determined as the third dimension. The time dimension represents a temporal position relationship between image feature units and text feature units, and the spatial dimensions represent spatial position relationships among the image feature units.

For a target feature unit 401 corresponding to the image, the target feature unit 401 corresponds to a plurality of image blocks in the image. According to the sequence position, a plurality of index information items [2,0,0]~[2,2,2] corresponding to the target feature unit 401 may be determined. Among the index information [2,0,0]~[2,2,2], the value in the first position is the second value of the first dimension, the value in the second position is the third value of the second dimension, and the value in the third position is the fourth value of the third dimension. For example, taking the index information [2,1,0] of the target feature unit 401 as an example, “2” is the second value of the first dimension, “1” is the third value of the second dimension, and “0” is the fourth value of the third dimension.

In some embodiments, in tasks such as image editing and multi-image generation, the model needs to refer to a historical image to perform the generation task. If the input visual content is an image, a value corresponding to the space dimension in the index information of the target feature unit corresponding to the image may be set to start from 0, that is, [0,0]~[2,2]. Moreover, multiple feature units corresponding to the image are associated with the same sequence position. For example, referring to FIG. 4, in the index information corresponding to the target feature unit 401 and the target feature unit 403, the values corresponding to the space dimension are the same, for example, in [2,0,0] and [9,0,0], the space dimensions all correspond to [0,0]. In this way, it may be ensured that all images have consistent position information in space.

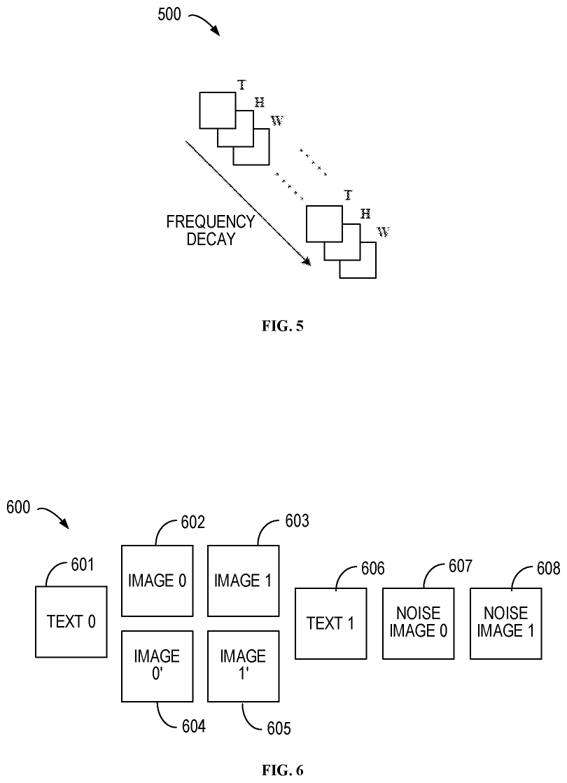

In some embodiments, to ensure that long-distance semantic association or local semantic association may be obtained in each dimension, rotary position embedding may be applied to alternately incorporate frequency information of multiple dimensions into the embedding vector. For example, referring to FIG. 5, the frequency information of the multiple dimensions may be alternately incorporated into the embedding vector in the order of the time dimension T, the height H of the space dimension, and the width W of the space dimension. The formula is as follows:

$${θ}_{T} = \{ {β}^{- \frac{2 i}{d}} \vert i = 3 j \} ; {θ}_{H} = \{ {β}^{- \frac{2 i}{d}} \vert i = 3 j + 1 \} ;$$

$${θ}_{W} = \{ {β}^{- \frac{2 i}{d}} \vert i = 3 j + 2 \}$$

θ represents a rotary frequency applied to a specific size, β represents a fundamental frequency, d represents the number of dimensions, and i and j are variables. In addition, the first 48 channels may be alternately allocated to the time dimension, the height in the space dimension, and the width in the space dimension, and then the remaining 16 channels are allocated to the time dimension, to model a long sequence.

At block 240, the electronic device 110 obtains at least one output feature unit generated by the target model based on the sequence of input feature units, to generate response content for the processing request.

In some embodiments, the at least one output feature unit includes a set of text feature units and a set of visual feature units, and the response content includes output text content corresponding to the set of text feature units and output visual content corresponding to the set of visual feature units. For example, with reference to FIG. 8, the input content 801 of the target model is “xxx”, and the response content output by the target model includes output text content 802 “Step 1, aaa”, output visual content 803, output text content 804 “Step 2, bbb”, output visual content 805, output text content 806 “Step 3, ccc”, and output visual content 807.

In some embodiments, the input content of the target model may not only be text but also be mixed content of an image and text. The output content of the target model may not only be text but also an image or mixed content of an image and text, which is not limited herein.

In some embodiments, since the response content includes both output text content and output visual content, it is necessary to determine, through an indicator, what modality of content the target model needs to generate. If the electronic device 110 detects a predetermined first indicator from an output result of the target model, the electronic device 110 may perform, in response to detection of the indicator, a denoising process using the target model to generate a set of visual feature units. The first indicator <|vision_start|> is used to indicate the target model to generate an image. For example, if the output result of the model includes the first indicator, the target model may recognize that an image needs to be generated at the current time, and then may perform a denoising process of a diffusion model using the target model to generate the set of visual feature units.

In some embodiments, the electronic device 110 may further output a predetermined second indicator in response to generation of the set of visual units based on the denoising process. The second indicator <|vision_end|> is used to indicate that the target model generates text. For example, if, at the current time, the image generation task has been completed and the set of visual units has been generated, the second indicator may be output to indicate the target model to subsequently output text, thereby generating a form in which text and images are alternately output, as shown in FIG. 8.

In some embodiments, the electronic device 110 may further determine a third visual feature of the output visual content using the first visual encoding model, and determine a fourth visual feature of the output visual content using the second visual encoding model. Then, based on the third visual feature and the fourth visual feature, the sequence of input feature units is updated, so that subsequent output feature units are generated by the target model. Since the target model includes a plurality of processing blocks, the sequence of feature units output from the current processing block may be used as the sequence of input feature units of the next processing block.

In some embodiments, during training of the target model, the electronic device 110 may obtain sample data, and then construct a sequence of training feature units based on the sample data. Subsequently, based on a task type of a training task associated with the target model, an attention mask corresponding to the task type is determined. Then, based on the sequence of training feature units and the attention mask, the target model is trained. The attention mask is a method used to control a calculation range of an attention mechanism. Through a mask matrix, it is determined which input information can interact with each other and which should be ignored. Its core function is to constrain the allocation of attention weights.

In some embodiments, with reference to FIG. 3A, for an image generation task, during training, reference visual content 314 may be obtained, and features of the reference visual content 314 are extracted using a VAE model 312, and noise 313 is added to the features. During inference, the reference visual content 314 is not required, and noise is directly input.

In some embodiments, the target model needs to alternately generate response content of different modalities, such as image-text-image-text. During model training, since images are generated through a diffusion model, noise is added during training, causing the training of subsequent modalities to depend on these noise-contaminated images. During training, the input of subsequent modalities is noisy images, whereas during inference, the model actually generates clean images. That is, during training, the model learns a mapping of “noisy image—text”, but during inference, the model needs to handle a mapping of “clean image—text”. This inconsistency may cause domain shift, resulting in degradation of model performance. Therefore, the model can be trained by an efficient full teacher forcing method. The efficient full teacher forcing method can solve the problem of inconsistency between the training process and the inference process in a multimodal interleaved generation task.

In some embodiments, the sample data includes first sample text, first sample visual content, second sample visual content, and second sample text, and the sequence of training feature units includes: (with reference to FIG. 6) text 601 that is a first part corresponding to the first sample text, an image 602 that is a second part corresponding to a first training visual feature of the first sample visual content, an image 604 that is a third part corresponding to a second training visual feature of the first sample visual content, an image 603 that is a fourth part corresponding to a third training visual feature of the second sample visual content, an image 605 that is a fifth part corresponding to a fourth training visual feature of the second sample visual content, text 606 that is a sixth part corresponding to the second sample text, a noise image 607 that is a seventh part corresponding to a first noise visual feature of the first sample visual content, and a noise image 608 that is an eighth part corresponding to a second noise visual feature of the second sample visual content.

The first training visual feature is determined using the first visual encoding model, the second training visual feature is determined using the second visual encoding model, the third training visual feature is determined using the first visual encoding model, and the second training visual feature is determined using the second visual encoding model.

In some embodiments, since all image modalities are subjected to noise perturbation by a diffusion model during training, inputs of subsequent modalities are forced to depend on these noisy images, resulting in inconsistency between training and inference. Moreover, if some tasks do not require noisy images, forcing all images to be noised introduces unnecessary computational overhead. Therefore, the training data may be divided into clean data and noisy data, where the clean data refers to data without added noise, and the noisy data refers to data with added noise. By separating the clean data and the noisy data, the model can more efficiently learn different tasks, thereby avoiding interference of noise with non-diffusion tasks.

In some embodiments, determining, based on the task type of the training task associated with the target model, the attention mask corresponding to the task type includes at least one of: determining a first attention mask in response to the training task being a text generation task associated with second sample text content, the first attention mask indicating that a sixth part is associated with a first part, a third part, and a fifth part; determining a second attention mask in response to the training task being a visual content generation task associated with first sample visual content, the second attention mask indicating that a seventh part is associated with the first part; or determining a third attention mask in response to the training task being a visual content generation task associated with second sample visual content, the second attention mask indicating that an eighth part is associated with the first part, the second part, and the third part.

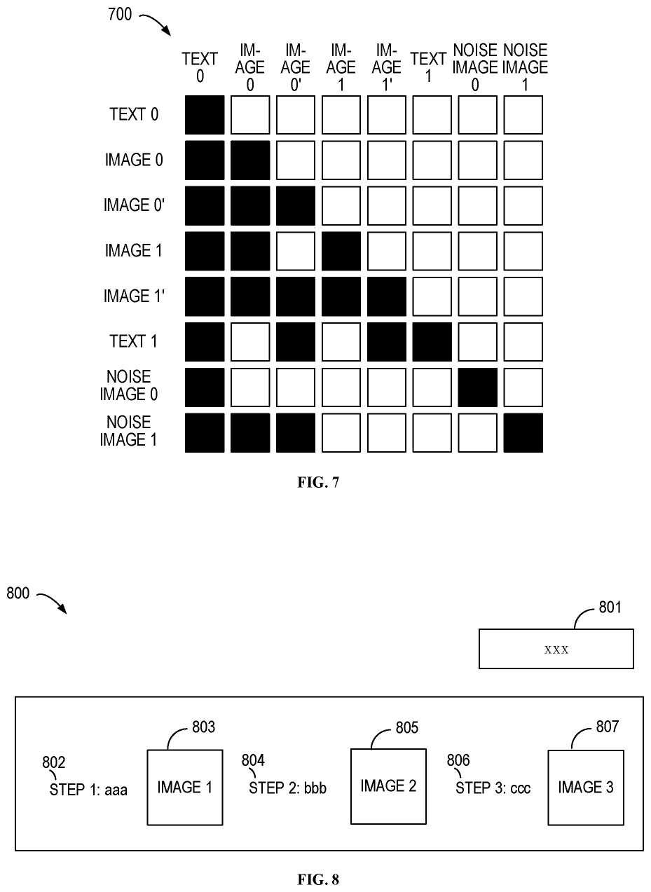

For example, with reference to FIG. 7, the sixth part (Text 1) is associated with the first part (Text 0), the third part (Image 0′), and the fifth part (Image 1′) in black, indicating that the historical information corresponding to the sixth part includes the first part (Text 0), the third part (Image 0′), and the fifth part (Image 1′), while the rest is masked. The seventh part is associated with the first part (Text 0) in black, indicating that the historical information corresponding to the seventh part includes the first part (Text 0), while the rest is masked. The eighth part is associated with the first part (Text 0), the second part (Image 0), and the third part (Image 0′) in black, indicating that the historical information corresponding to the eighth part includes the first part (Text 0), the second part (Image 0), and the third part (Image 0′), while the rest is masked.

Through the attention mask shown in FIG. 7, the target model may focus only on clean data when generating text, and focus on noisy data and associated text when generating images. By this method, noisy data does not need to be processed during text generation, saving computational power, and the text decoder is always trained based on clean data, which aligns with inference conditions.

In some embodiments, model generation quality can also be improved by classifier-free guidance. Classifier-free guidance is a commonly used technique in generative models, which is used to balance the determinism and randomness of the model during sample generation, thereby improving the quality and controllability of the generated samples. This technique combines conditional prediction and unconditional prediction to generate results that better conform to specified conditions. The formula is as follows:

∇ₓ log p(x|c)=γ(∇ₓ log p(x|c)−∇ₓ log p(x))+∇ₓ log p(x)
c represents a condition, the condition c may be decomposed into the image modality c_{img} and the text modality cₜₓₜ, and γ represents a classifier-free guidance coefficient. The image in the condition may provide a shortcut for the model to generate a subsequent image, resulting in a phenomenon similar to time stagnation. The influence of different modalities may also be controlled by introducing different classifier-free guidance coefficients γ and γ_{img}. The formula is as follows:

∇ₓ log p(x|c_{img},cₜₓₜ)=γ(∇ₓ log p(x|c_{img},cₜₓₜ)−∇ₓ log p(x|c_{img}))+γ_{img}(∇ₓ log p(x|c_{img})−∇ₓ log p(x))+∇ₓ log p(x)

To be able to effectively adjust the influence of different modes on image generation, the classifier-free guidance coefficients γ=7.5 and γ_{img}=1.5 may be used separately.

In some embodiments, the fixed resolution strategy reduces the efficiency of both model training and inference, and limits the visual understanding ability of the model. Therefore, a native resolution strategy may be adopted to perform processing by using original resolution information of an image as much as possible, to reduce unnecessary information loss or distortion. An input image may be converted into a variable number of visual feature units, that is, the number of finally generated visual feature units is not fixed and may change according to the actual situation, based on the content and features of the image. In addition, during the process of converting the image into visual tokens, the original aspect ratio of the image is not changed, so that the shape feature of the image may be ensured not to be distorted.

In some embodiments, when a plurality of GPUs are used to train a complex multimodal model together, the loss and weight of each data sample on different GPUs are different. Therefore, a proper balance point needs to be found, to enable the model to perform well on different tasks. For example, the weights may be first added up on each GPU to obtain an average weight, and then the average weight is normalized, to obtain an approximate but unbiased gradient. Since only a small amount of scalar data needs to be transmitted between graphics cards, and asynchronous communication is used, the communication cost is low, and the training efficiency is not affected. The formula may be as follows:

$$\frac{1}{N} {\sum }_{n} \frac{\partial }{\partial W} ( \frac{{\sum }_{i} {w}_{i}^{n} {L}_{i}^{n}}{\frac{1}{N} {\sum }_{n} {\sum }_{i} {w}_{i}^{n}} )$$

Lᵢⁿ is the loss of an i-th feature unit, wᵢⁿ is the weight, and n represents an n-th GPU.

In some embodiments, the model may be trained through the next token prediction (NTP) loss. The NTP loss is an indicator used to measure the performance of the model in the next token prediction task. The model is trained by minimizing the NTP loss, to enable the model to more accurately predict the next token in the sequence. For example, the model may be optimized by minimizing the cross entropy between the probability distribution output by the model and the data distribution. The formula for the NTP loss L_{NTP} is as follows:

L_{NTP}=E_{z}_{ᵢ}[−log P_{θ}_{_{VLM}}(zₗ₊₁|z₀, . . . ,zₗ,x)]

z=(z₀, . . . , z_{L}) represents the input text content, θ_{VLM} represents the parameters of the target model, x=(x₀, . . . , x_{N}) represents the image information, and x may be φ. The probability distribution output by the model is the probability distribution predicted and output by the model based on the input information, and the data distribution is the probability distribution of occurrence of each event in the real data. The cross entropy is an indicator used to measure a difference degree between two probability distributions. A smaller cross entropy indicates that the two distributions are closer. In this way, the probability distribution predicted by the model may be close to the distribution of the real data.

In some embodiments, the rectified flow matching method may also be used to model the generation distribution of the image. Flow matching is a method of mapping a simple distribution to a complex data distribution by learning a probability path. The core idea is to gradually transform noise data into target data by defining a continuous transformation path, and then approximate this ideal path by optimizing the model.

For example, an image distribution x-~r and a simple prior distribution ϵ∈N(0,1) may be set, and a linear trajectory defined with time t may be constructed. The formula is as follows:

xₜ=t·x+(1−t)·ε,t∈[0,1]

The following ordinary differential equation may be obtained through the above formula:

$$\frac{{dx}_{t}}{dt} = v ( {x}_{t} , t )$$

Velocity field v=x−ε. To generate an image, reverse time integration may be performed on the ordinary differential equation in the above formula starting from x₀~N(0,1),

$${x}_{1} = {\int }_{0}^{1} {v}_{θ} ( {x}_{t} , t ) dt .$$

Therefore, for the image generation task, the model may be trained by optimizing the flow matching loss. The formula for the flow matching loss L_{flow} is as follows:

$${L}_{flow} = {E}_{t , x \sim π , ε \sim N ( 0 , 1 )} ‖ {v}_{θ} ( {x}_{t} , t ) - ( x - ε ) {‖}_{2}^{2}$$

In some embodiments, the sequence distribution may be modeled in a causal manner at the modality level. The formula is as follows:

$$log {P}_{θ} ( x ) = {\sum }_{t = 0}^{T} log {P}_{θ} ( {x}_{t + 1} \vert {x}_{0} , … , {x}_{t} ) , {x}_{t} ∈ \{ {x}_{img} , {x}_{txt} \}$$

θ represents the parameters of the model, and xₜ represents the visual modality x_{img} or the text modality xₜₓₜ, instead of a single token. Moreover, the generated xₜ₊₁ is added to the historical information as a condition. Through this method, the target model may promote the generation of any modality conditioned on an arbitrary mixed modality, that is, interleaved multimodal generation.

In some embodiments, the loss function may include the NTP loss L_{NTP} and the flow matching loss L_{flow}. The formula for the overall loss Lₜₒₜₐₗ is as follows:

Lₜₒₜₐₗ=λ·L_{NTP}+L_{flow}

In some embodiments, during the training process, the target model may distinguish between the visual generation mode and the text generation mode using two indicators, and the first indicator <|vision_start|> and the second indicator <|visition_end|> may be inserted at the beginning and the end of all image sequences, respectively. During the inference process, whether to generate an image may be determined based on the context. For example, if the first indicator is generated, the mode is switched to the image generation mode; or if the second indicator is generated, the mode is switched to the text generation mode.

In the embodiments of the present disclosure, a plurality of visual encoding models may be applied to extract visual features, to enable the target model to simultaneously have the understanding ability and the image generation ability. Moreover, the position perception ability of the model may be improved by the multidimensional position embedding method. A plurality of attention units and a plurality of feedforward units are applied to process information of different modalities, so that feature units of the plurality of modalities may be deeply fused in each processing block, thereby generating a higher-quality response. In addition, during the model training process, the problem caused by the inconsistency between the training process and the inference process may be reduced by applying the attention mask.

### Example Apparatus and Device

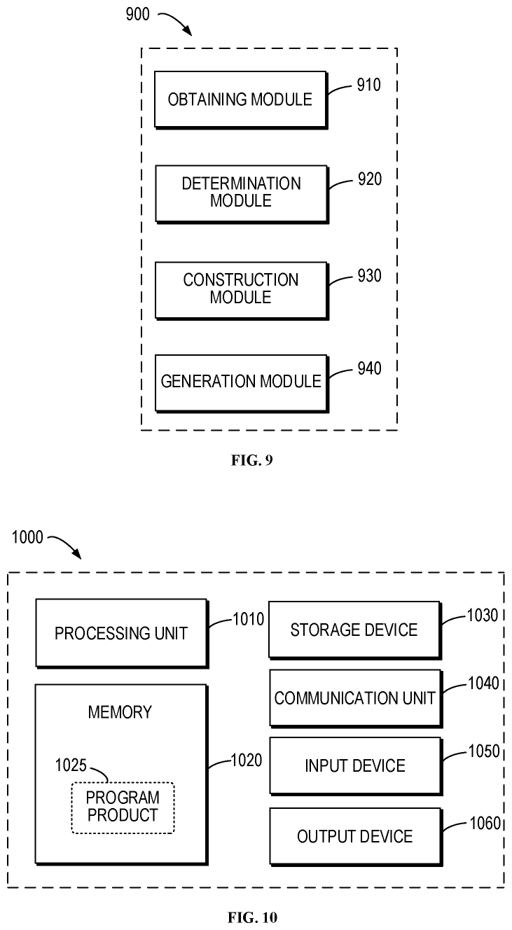

The embodiments of the present disclosure further provide a corresponding apparatus for implementing the above methods or processes. FIG. 9 illustrates a schematic structural block diagram of an apparatus 900 for touch interaction according to some embodiments of the present disclosure. The apparatus 900 may be implemented as, or included in, the electronic device 110 discussed above. Each module/component in the apparatus 900 may be implemented by hardware, software, firmware, or any combination thereof.

As shown in FIG. 9, the apparatus 900 includes: an obtaining module 910 configured to obtain a processing request for a target model; a determination module 920 configured to determine, in response to the processing request including input visual content, a first visual feature of the input visual content using a first visual encoding model, and determine a second visual feature of the input visual content using a second visual encoding model, the first visual encoding model being different from the second visual encoding model; a construction module 930 configured to construct a sequence of input feature units corresponding to the processing request at least based on the first visual feature and the second visual feature; and a generation module 940 configured to obtain at least one output feature unit generated by the target model based on the sequence of input feature units, to generate response content for the processing request.

In some embodiments, the at least one output feature unit includes a set of text feature units and a set of visual feature units, and the response content includes output text content corresponding to the set of text feature units and output visual content corresponding to the set of visual feature units.

In some embodiments, the apparatus 900 is further configured to detect a predetermined first indicator from an output result of the target model, and in response to detection of the indicator, perform a denoising process using the target model to generate a set of visual feature units.

In some embodiments, the target model is further configured to output a predetermined second indicator in response to generation of a set of visual units based on the denoising process.

In some embodiments, the apparatus 900 is further configured to determine a third visual feature of output visual content using the first visual encoding model, determine a fourth visual feature of the output visual content using the second visual encoding model, and update the sequence of input feature units based on the third visual feature and the fourth visual feature, so that subsequent output feature units are generated by the target model.

In some embodiments, the construction module 930 is configured to determine a text feature corresponding to input text content, and construct the sequence of input feature units corresponding to the processing request based on the first visual feature, the second visual feature, and the text content.

In some embodiments, the sequence of input feature units includes a visual sequence part corresponding to the first visual feature and the second visual feature, and the visual sequence part is associated with a predetermined indicator.

In some embodiments, the target model includes a plurality of processing blocks, each of the processing blocks including a first attention unit, a second attention unit, and a fusion unit. The first attention unit is configured to process the first visual feature and a text feature unit in the sequence of input feature units, the second attention unit is configured to process the second visual feature, and the fusion unit is configured to fuse a first output result of the first attention unit and a second output result of the second attention unit.

In some embodiments, a first set of parameters of the first attention unit is independent of a second set of parameters of the second attention unit.

In some embodiments, the target model is configured to determine, for a target feature unit in the sequence of input feature units, index information of the target feature unit based on a position of the target feature unit in the sequence of input feature units and a type of the target feature unit, and determine attention information associated with the target feature unit based on the index information.

In some embodiments, the apparatus 900 is configured to determine, in response to the target feature unit corresponding to text content, a first value of a first dimension of the index information based on a sequence position, and set other dimensions of the index information to predetermined values.

In some embodiments, the apparatus 900 is configured to determine, in response to the target feature unit corresponding to an image block in an image, a second value of a first dimension of the index information based on a sequence position, where a plurality of feature units corresponding to the image are associated with a same sequence position, and determine a third value of a second dimension of the index information and a fourth value of a third dimension of the index information based on a two-dimensional position of the image block in the image.

In some embodiments, the target model is trained based on the following process: obtaining sample data; constructing a sequence of training feature units based on the sample data; determining, based on a task type of a training task associated with the target model, an attention mask corresponding to the task type; and training the target model based on the sequence of training feature units and the attention mask.

In some embodiments, the sample data includes first sample text, first sample visual content, second sample visual content, and second sample text, and the sequence of training feature units includes: a first part corresponding to the first sample text; a second part corresponding to a first training visual feature of the first sample visual content, the first training visual feature being determined using the first visual encoding model; a third part corresponding to a second training visual feature of the first sample visual content, the second training visual feature being determined using the second visual encoding model; a fourth part corresponding to a third training visual feature of the second sample visual content, the third training visual feature being determined using the first visual encoding model; a fifth part corresponding to a fourth training visual feature of the second sample visual content, the fourth training visual feature being determined using the second visual encoding model; a sixth part corresponding to the second sample text; a seventh part corresponding to a first noise visual feature of the first sample visual content; and an eighth part corresponding to a second noise visual feature of the second sample visual content.

In some embodiments, determining, based on the task type of the training task associated with the target model, the attention mask corresponding to the task type includes at least one of: determining the first attention mask in response to the training task being a text generation task associated with second sample text content, the first attention mask indicating that the sixth part is associated with the first part, the third part, and the fifth part; determining the second attention mask in response to the training task being a visual content generation task associated with first sample visual content, the second attention mask indicating that the seventh part is associated with the first part; or determining the third attention mask in response to the training task being a visual content generation task associated with second sample visual content, the third attention mask indicating that the eighth part is associated with the first part, the second part, and the third part.

In some embodiments, the first visual encoding model includes a vision transformer-based encoding model, and the second visual encoding model includes a variational autoencoder-based encoding model.

The units included in the apparatus 900 may be implemented in various ways, including software, hardware, firmware, or any combination thereof. In some embodiments, one or more units may be implemented by software and/or firmware, for example, machine-executable instructions stored in a storage medium. In addition to, or as an alternative to, machine-executable instructions, some or all of the units in the apparatus 900 may be implemented at least partially by one or more hardware logic components. As an example rather than a limitation, example types of hardware logic components that may be used include field-programmable gate arrays (FPGAs), application-specific integrated circuits (ASICs), application-specific standard products (ASSPs), system-on-chips (SoCs), and complex programmable logic devices (CPLDs), among others.

FIG. 10 shows a block diagram of an electronic device 1000 in which one or more embodiments of the present disclosure may be implemented. It should be understood that the electronic device 1000 shown in FIG. 10 is only illustrative, and should not constitute any limitation on the functions and scope of the embodiments described herein. The electronic device 1000 shown in FIG. 10 may be used to implement the electronic device 110 shown in FIG. 1.

As shown in FIG. 10, an electronic device 1000 is in a form of a general electronic device. Components of the electronic device 1000 may include but are not limited to one or more processors or processing units 1010, a memory 1020, a storage device 1030, one or more communication units 1040, one or more input devices 1050, and one or more output devices 1060. The processing unit 1010 may be an physical or virtual processor, and can perform various processes based on a program stored in the memory 1020. In a multi-processor system, a plurality of processing units execute computer-executable instructions in parallel to improve a parallel processing capability of the electronic device 1000.

The electronic device 1000 typically includes a plurality of computer storage medium. Such medium may be any available medium accessible by the electronic device 1000, including but not limited to volatile and non-volatile medium, and removable and non-removable medium. The memory 1020 may be a volatile memory (for example, a register, a cache, a random access memory (RAM)), a non-volatile memory (for example, a read-only memory (ROM), an electrically erasable programmable read-only memory (EEPROM), a flash memory), or any combination thereof. The storage device 1030 may be any removable or non-removable medium, and may include a machine-readable medium such as a flash drive, a disk, or any other medium, which may be used to store information and/or data (e.g., training data for training) and may be accessed within the electronic device 1000.

The electronic device 1000 may further include additional removable/non-removable, volatile/non-volatile memory medium. Although not shown in FIG. 10, a disk driver for reading from or writing into a removable, non-volatile disk (such as a “floppy disk”), and an optical disk driver for reading from or writing into a removable, non-volatile optical disk may be provided. In these cases, each driver may be connected to a bus (not shown) by one or more data medium interfaces. The memory 1020 may include a computer program product 1025 having one or more program modules configured to perform various methods or actions of various embodiments of the present disclosure.

The communication unit 1040 enables communication with other electronic devices through the communication medium. Additionally, the functions of the components of the electronic device 1000 may be implemented by a single computing cluster or a plurality of computing machines, which may communicate through a communication connection. Therefore, the electronic device 1000 may use a logical connection with one or more other servers, a network personal computer (PC), or another network node to operate in a networked environment.

The input device 1050 may be one or more input devices, such as a mouse, a keyboard, a tracking ball, etc. The output device 1060 may be one or more output devices, such as a display, a speaker, a printer, etc. The electronic device 1000 may further communicate with one or more external devices (not shown) such as a storage device and a display device as needed through the communication unit 1040, communicate with one or more devices that enable the user to interact with the electronic device 1000, or communicate with any devices (such as a network card and a modem) that enable the electronic device 1000 to communicate with one or more other electronic devices. Such communication may be performed via input/output (I/O) interfaces (not shown).

According to an example implementation of the present disclosure, a computer-readable storage medium is provided, having computer-executable instructions stored thereon, where the computer-executable instructions are executed by a processor to implement the method described above. According to an example implementation of the present disclosure, there is further provided a computer program product, the computer program product is tangibly stored on a non-transitory computer-readable medium and includes computer-executable instructions, and the computer-executable instructions are executed by a processor to implement the method described above.

Various aspects of the present disclosure are described herein with reference to flowcharts and/or block diagrams of methods, apparatuses, devices, and computer program products implemented according to the present disclosure. It should be understood that each block of the flowcharts and/or block diagrams, and combinations of blocks in the flowcharts and/or block diagrams may be implemented by computer-readable program instructions.

These computer-readable program instructions may be provided to a processing unit of a general-purpose computer, a special-purpose computer, or other programmable data processing apparatus to produce a machine, so that when these instructions are executed by the processing unit of the computer or other programmable data processing apparatus, an apparatus that implements the functions/actions specified in one or more blocks of the flowcharts and/or block diagrams is produced. These computer-readable program instructions may also be stored in a computer-readable storage medium, these instructions cause the computer, the programmable data processing apparatus, and/or other devices to work in a specific manner, and thus, the computer-readable medium storing the instructions includes a manufactured product, which includes instructions for implementing various aspects of the functions/actions specified in one or more blocks of the flowcharts and/or block diagrams.

The computer-readable program instructions may be loaded onto a computer, another programmable data processing apparatus, or other devices, so that a series of operation steps are performed on the computer, the another programmable data processing apparatus, or the other devices to produce a computer-implemented process, and thus, the instructions executed on the computer, the another programmable data processing apparatus, or the other devices implement the functions/actions specified in one or more blocks of the flowcharts and/or block diagrams.

The flowcharts and block diagrams in the figures show the possibly implemented architectures, functions, and operations of the system, the method, and the computer program product according to a plurality of implementations of the present disclosure. In this regard, each block in the flowchart or block diagram may represent a module, a program segment, or a portion of instructions, and the module, the program segment, or the portion of instructions contains one or more executable instructions for implementing the specified logical functions. In some alternative implementations, the functions marked in the blocks may also occur in an order different from that marked in the figures. For example, two consecutive blocks may actually be performed substantially in parallel, or they may sometimes be performed in the reverse order, depending on the functions involved. It should also be noted that each block in the block diagrams and/or flowcharts, and a combination of the blocks in the block diagrams and/or flowcharts may be implemented by a special-purpose hardware-based system that executes specified functions or actions, or may be implemented by a combination of special-purpose hardware and computer instructions.

The implementations of the present disclosure have been described above, and the above description is illustrative, non-exhaustive, and not limited to the disclosed implementations. Without departing from the scope and gist of the illustrated implementations, many modifications and changes are obvious to those of ordinary skill in the art. The terms used herein are selected to best explain the principles of the implementations, the actual applications or improvements to the technologies in the market, or to enable other persons of ordinary skill in the art to understand the implementations disclosed herein.

1. A method for information processing, comprising:
obtaining a processing request for a target model;
determining a first visual feature of the input visual content using a first visual encoding model and determining a second visual feature of input visual content using a second visual encoding model in response to the processing request comprising the input visual content, the first visual encoding model being different from the second visual encoding model;
constructing a sequence of input feature units corresponding to the processing request at least based on the first visual feature and the second visual feature; and
obtaining at least one output feature unit generated by the target model based on the sequence of input feature units, to generate response content for the processing request.

2. The method of claim 1, wherein the at least one output feature unit comprises a set of text feature units and a set of visual feature units, and the response content comprises output text content corresponding to the set of text feature units and output visual content corresponding to the set of visual feature units.

3. The method of claim 2, further comprising:
detecting a predetermined first indicator from an output result of the target model; and
performing a denoising process using the target model in response to detection of the first indicator, to generate the set of visual feature units.

4. The method of claim 3, wherein the target model is further configured to:
output a predetermined second indicator in response to generation of the set of visual units based on the denoising process.

5. The method of claim 2, further comprising:
determining a third visual feature of the output visual content using the first visual encoding model, and determining a fourth visual feature of the output visual content using the second visual encoding model; and
updating the sequence of input feature units based on the third visual feature and the fourth visual feature, to generate a subsequent output feature unit with the target model.

6. The method of claim 1, wherein the processing request further comprises input text content, and constructing the sequence of input feature units corresponding to the processing request at least based on the first visual feature and the second visual feature comprises:
determining a text feature corresponding to the input text content; and
constructing the sequence of input feature units corresponding to the processing request based on the first visual feature, the second visual feature and the text content.

7. The method of claim 6, wherein the sequence of input feature units comprises a visual sequence part corresponding to the first visual feature and the second visual feature, and the visual sequence part is associated with a predetermined indicator.

8. The method of claim 1, wherein the target model comprises a plurality of processing blocks, each of the processing blocks comprises a first attention unit, a second attention unit and a fusion unit, and the first attention unit is configured to process the first visual feature and a text feature unit in the sequence of input feature units, the second attention unit is configured to process the second visual feature, and the fusion unit is configured to fuse a first output result of the first attention unit and a second output result of the second attention unit.

9. The method of claim 8, wherein a first set of parameters of the first attention unit is independent of a second set of parameters of the second attention unit.

10. The method of claim 1, wherein the target model is configured to:
determine, for a target feature unit in the sequence of input feature units, index information of the target feature unit based on a sequence position of the target feature unit in the sequence of input feature units and a type of the target feature unit; and
determine attention information associated with the target feature unit based on the index information.

11. The method of claim 10, wherein determining the index information of the target feature unit based on the sequence position of the target feature unit in the sequence of input feature units and the type of the target feature unit comprises:
determining, in response to the target feature unit corresponding to text content, a first value of a first dimension of the index information based on the sequence position; and
setting other dimension of the index information to a predetermined value.

12. The method of claim 10, wherein determining the index information of the target feature unit based on the sequence position of the target feature unit in the sequence of input feature units and the type of the target feature unit comprises:
determining, in response to the target feature unit corresponding to an image block in an image, a second value of a first dimension of the index information based on the sequence position, wherein a plurality of feature units corresponding to the image are associated with a same sequence position; and
determining a third value of a second dimension of the index information and a fourth value of a third dimension of the index information based on a two-dimensional position of the image block in the image.

13. The method of claim 1, wherein the target model is trained based on:
obtaining sample data;
constructing a sequence of training feature units based on the sample data;
determining, based on a task type of a training task associated with the target model, an attention mask corresponding to the task type; and
training the target model based on the sequence of training feature units and the attention mask.

14. The method of claim 13, wherein the sample data comprises first sample text, first sample visual content, second sample visual content and second sample text, and the sequence of training feature units comprises:
a first part corresponding to the first sample text;
a second part corresponding to a first training visual feature of the first sample visual content, the first training visual feature being determined using the first visual encoding model;
a third part corresponding to a second training visual feature of the first sample visual content, the second training visual feature being determined using the second visual encoding model;
a fourth part corresponding to a third training visual feature of the second sample visual content, the third training visual feature being determined using the first visual encoding model;
a fifth part corresponding to a fourth training visual feature of the second sample visual content, the second training visual feature being determined using the second visual encoding model;
a sixth part corresponding to the second sample text;
a seventh part corresponding to a first noise visual feature of the first sample visual content; and
an eighth part corresponding to a second noise visual feature of the second sample visual content.

15. The method of claim 14, wherein determining, based on the task type of the training task associated with the target model, the attention mask corresponding to the task type comprises at least one of:
determining a first attention mask in response to the training task being a text generation task associated with the second sample text content, the first attention mask indicating that the sixth part is associated with the first part, the third part and the fifth part;
determining a second attention mask in response to the training task being a visual content generation task associated with the first sample visual content, the second attention mask indicating that the seventh part is associated with the first part; or
determining a third attention mask in response to the training task being a visual content generation task associated with the second sample visual content, the second attention mask indicating that the eighth part is associated with the first part, the second part and the third part.

16. The method of claim 1, wherein the first visual encoding model comprises a vision transformer-based encoding model, and the second visual encoding model comprises a variational autoencoder-based encoding model.

17. An electronic device, comprising:
at least one processor; and
at least one memory coupled to the at least one processor and storing instructions for execution by the at least one processor, the instructions, when executed by the at least one processor, causing the electronic device to perform acts comprising:
obtaining a processing request for a target model;
determining a first visual feature of input visual content using a first visual encoding model and determining a second visual feature of the input visual content using a second visual encoding model in response to the processing request comprising the input visual content, the first visual encoding model being different from the second visual encoding model;
constructing a sequence of input feature units corresponding to the processing request at least based on the first visual feature and the second visual feature; and
obtaining at least one output feature unit generated by the target model based on the sequence of input feature units, to generate response content for the processing request.

18. The electronic device of claim 17, wherein the at least one output feature unit comprises a set of text feature units and a set of visual feature units, and the response content comprises output text content corresponding to the set of text feature units and output visual content corresponding to the set of visual feature units.

19. The electronic device of claim 18, wherein the acts further comprise:
detecting a predetermined first indicator from an output result of the target model; and
performing a denoising process using the target model in response to detection of the first indicator, to generate the set of visual feature units.

20. A computer-readable storage medium having a computer program stored thereon, the computer program, when executed by a processor, performing acts comprising:
obtaining a processing request for a target model;
determining a first visual feature of input visual content using a first visual encoding model and determining a second visual feature of the input visual content using a second visual encoding model in response to the processing request comprising the input visual content, the first visual encoding model being different from the second visual encoding model;
constructing a sequence of input feature units corresponding to the processing request at least based on the first visual feature and the second visual feature; and
obtaining at least one output feature unit generated by the target model based on the sequence of input feature units, to generate response content for the processing request.
